(19) United States
(12) Patent Application Publication
(10) Pub. No.: US 2012/0033307 A1
(43) Pub. Date: Feb. 9, 2012

(54) DISPLAY DEVICE

(75) Inventors: Hiroaki Nakamura, Kanagawa-ken (JP); Akihisa Moriya, Kanagawa-ken (JP)

(73) Assignee: KABUSHIKI KAISHA TOSHIBA, Tokyo (JP)

(21) Appl. No.: 13/041,571

(22) Filed: Mar. 7, 2011

(30) Foreign Application Priority Data
Aug. 6, 2010 (JP) P2010-177897

(51) Int. Cl. G02B 27/01

(52) U.S. Cl. 359/632

(57) ABSTRACT

A display device includes a light flux generation unit 115 to generate light flux 112 containing image information, a reflection plate 163 to reflect the light flux toward one eye 105 of an occupant 100, a head detection unit 612 to detect a head 101 of the occupant 100 by utilizing at least two pairs of distance sensors, a control unit 620 to determine the position of the head 101 of the occupant 100 as receiving output from the head detection unit 612 and to control a direction or a position of the reflection plate 163, and a drive unit 164 to drive the reflection plate 163 as receiving output from the control unit 620.

### CROSS REFERENCE TO RELATED APPLICATION

This application is based upon and claims the benefit of priority from the prior Japanese Patent Application No. 2010-177897, filed on Aug. 6, 2010, the entire contents of which are incorporated herein by reference.

### FIELD

Embodiments basically relate to a display device.

### BACKGROUND

As a display device for automobile use, there has been a single-eyed head up display (HUD) capable of visually identifying operation information such as vehicle speeds and traveling directions.

In such an HUD, a position of an eye of an occupant is derived from a picked-up image of a head of the occupant. An angle and a position of a plate mirror are automatically controlled on the basis of the derived result. A projected image is presented to one eye of the occupant as tracing movement of the head of the occupant.

However, with this HUD, it is difficult to robustly present projected image to one eye of an occupant.

### BRIEF DESCRIPTION OF DRAWINGS

Aspects of this disclosure will become apparent upon reading the following detailed description and upon reference to accompanying drawings. The description and the associated drawings are provided to illustrate embodiments of the invention and not limited to the scope of the invention.

FIG. 1 is a view showing a configuration of a display device according to a first embodiment.

FIGS. 2A and 2B are views showing a configuration of a part of the display device.

FIG. 3 is a flow chart exemplifying a control method of a control unit.

### DESCRIPTION

As will be described below, according to an embodiment, a display device includes a light flux generation unit, a reflection plate, a head detection unit, a control unit and a drive unit. The light flux generation unit generates light flux containing image information. The reflection plate reflects the light flux generated by the light flux generation unit toward one eye of an occupant. The drive unit drives the reflection plate on the basis of an output from the control unit. In addition, the head detection unit utilizes a first distance sensor pair having a distance sensor A and a distance sensor B and a second distance sensor pair having a distance sensor C and a distance sensor D to detect a position of a head of the occupant. The control unit calculates a coefficient G from output voltage difference of the first distance sensor pair and output voltage difference of the second distance sensor pair when an output voltage of the distance sensor A and an output voltage of the distance sensor D become equal to each other, or controls a direction or a position of the reflection plate on the basis of the coefficient G and either the output voltage difference of the first distance sensor pair or the output voltage difference of the second distance sensor pair.

In the following, embodiments will be described in detail with reference to the drawings.

In this specification and the drawings, the same reference numeral will be given to an element being similar to the element previously described with reference to any referred drawing and detailed explanations will not be repeated.

### First Embodiment

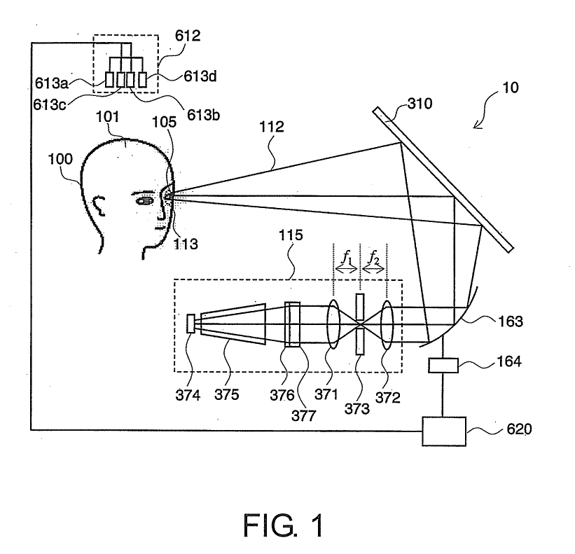

FIG. 1 is a schematic view exemplifying a configuration of a display device according to a first embodiment. For example, with the display device, an occupant 100 driving a vehicle can visually identify operation information such as a vehicle speed and navigation information.

A display device 10 is provided with a light flux generation unit 115, a reflection plate 163, a head detection unit 612, a control unit 620 and a drive unit 164.

The light flux generation unit 115 generates light flux 112 containing image information of operation information. The reflection plate 163 reflects the light flux 112 generated by the light flux generation unit 115 toward a clear plate 310 such as a front glass and a windshield. The clear plate 310 reflects the light flux 112 toward one eye 105 of the occupant 100.

The light flux generation unit 115 is provided with a light source 374, a restriction portion 375, a diffusion portion 376, an image unit 377, a first lens 371, an opening portion 373, and a second lens 372. Assuming that the focal length of the first lens 371 is denoted by f₁ and the focal length of the second lens 372 is denoted by f₂, the opening portion 373 is disposed at a position of a distance of f₁ from the first lens 371 and a distance of f₂ from the second lens 372.

The light flux 112 emitted from the light source 374 enters the image unit 377 which has the diffusion portion 376 in a state that the traveling direction thereof is restricted to be directed to the reflection plate 163 by the restriction portion 375. The light flux 112 is capable of evenly entering the image unit 377 as a result of the diffusion portion 376.

The light flux 112 passes through the image unit 377 to contain image information and further passes through the first lens 371, the opening portion 373 and the second lens 372. The light flux 112 is incident on the reflection plate 163 in a state that a divergence angle thereof (i.e., a diffuse angle of the light flux 112) is controlled.

The image unit 377 is placed on the light source 374 side from the opening portion 373, thereby allowing it to enhance a passing rate of the light flux 112 passing through the image unit 377 compared to a case that the opening portion 373 is placed on the light source 374 side from the image unit 377.

A light-emitting diode, a high-pressure mercury lamp, a halogen lamp, a laser and the like may be employed as the light source 374. A tapered light guide is employed as the restriction portion 375. A diffusion filter or a diffusion plate is employed as the diffusion portion 376. A liquid crystal display, a digital mirror device or the like is employed as the image unit 377.

The display device 10 projects the light flux 112 in a projection range 113 which includes the one eye 105 of the occupant 100. The control unit 620 controls a direction or a position of the reflection plate 163 so that the light flux 112 is projected within the projection range 113 and adjusts a projection position of the light flux 112. The occupant 100 can visually identify the light flux 112 with the one eye 105. The display device 10 can be used as an HUD.

The head detection unit 612 utilizes two pairs of distance sensors to detect relative distance between the head 101 of the occupant 100 and each distance sensor for the head 101 of the occupant 100.

As will be described later, the control unit 620 controls the reflection plate 163 on the basis of output signals from the pairs of distance sensors disposed at the head detection unit 612 to adjust the projection position of the light flux 112.

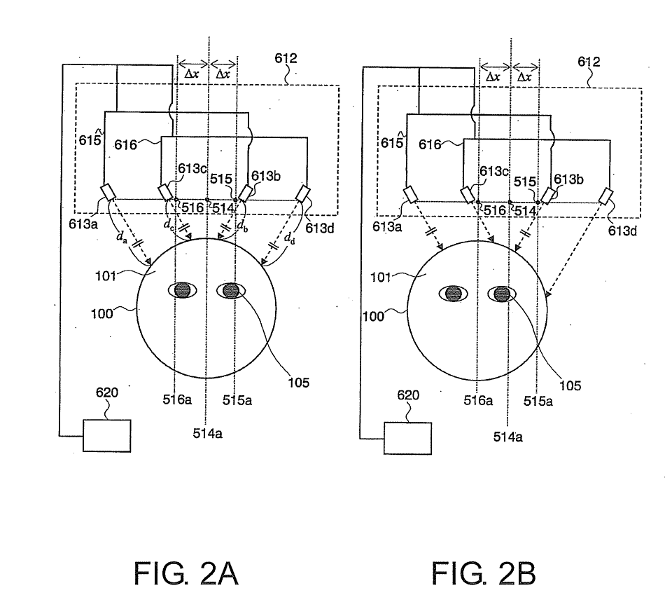

The head detection unit 612 will be explained in detail with reference to FIGS. 2A and 2B.

As shown in FIGS. 2A and 2B, the head detection unit 612 in the display device 10 is provided with a first distance sensor pair 615 having a distance sensor A 613a and a distance sensor B 613b and a second distance sensor pair 616 having a distance sensor C 613c and a distance sensor D 613d.

Each distance sensor is provided with a light emitting element and a light receiving element. The light emitting element emits light and the light receiving element receives returned light to be reflected by the head 105 of the occupant 100.

The distance sensors include a sensor capable of measuring a distance to an object without contacting thereto such as a laser displacement gauge and an ultrasonic distance sensor in addition to a PSD sensor.

Here, a first midpoint 514 denotes the midpoint of a line segment connecting the distance sensor C 613c and the distance sensor B 613b. A second midpoint 515 denotes the midpoint of a line segment connecting the distance sensor C 613c and the distance sensor D 613d. A third midpoint 516 denotes the midpoint of a line segment connecting the distance sensor A 613a and the distance sensor B 613b. The third midpoint 516 is located at the opposite side to the second midpoint 515 as sandwiching the first midpoint 514.

The line segment connecting the distance sensor C 613c and the distance sensor B 613b is defined as a line segment connecting a light receiving element of the distance sensor C 613c and a light receiving element of the distance sensor B 613b.

The line segment connecting the distance sensor C 613c and the distance sensor D 613d is defined as a line segment connecting a light receiving element of the distance sensor C 613c and a light receiving element of the distance sensor D 613d.

A perpendicular bisector of the line segment connecting the distance sensor C 613c and the distance sensor B 613b is denoted by a first line 514a. A perpendicular bisector of the line segment connecting the distance sensor C 613c and the distance sensor D 613d is denoted by a second line 515a. A perpendicular bisector of the line segment connecting the distance sensor A 613a and the distance sensor B 613b is denoted by a third line 516a.

The distance sensor C 613c and the distance sensor D 613d are arranged so that the light emitted from the distance sensor C 613c and the light emitted from the distance sensor D 613d intersect with each other on the second line 515a.

The distance sensor C 613c and the distance sensor D 613d are preferably arranged so that light is emitted toward a barycentric position when a geometric barycenter of the head 105 of the occupant 100 is positioned on the second line 515a.

The distance sensor A 613a and the distance sensor B 613b are arranged so that the light emitted from the distance sensor A 613a and the light emitted from the distance sensor B 613b intersect with each other on the third line 516a.

The distance sensor A 613a and the distance sensor B 613b are preferably arranged so that light is emitted toward a barycentric position when a geometric barycenter of the head 105 of the occupant 100 is positioned on the third line 516a.

When the display device is assumed to be for, e.g., automobile use, the distance sensor pairs 615, 616 are located at a ceiling.

The first distance sensor pair 615 is arranged so that the distance between the first midpoint 514 and the third midpoint 516 is to be apart by Δx. The second distance sensor pair 616 is arranged so that the distance between the first midpoint 514 and the second midpoint 515 is to be apart by Δx.

It is preferable that the first distance sensor pair 615 and the second distance sensor pair 616 are placed on the same straight line.

The head detection unit 612 outputs an output voltage value Vₐ of the distance sensor A 613a, an output voltage value V_{b} of the distance sensor B 613b, an output voltage value V_{c} of the distance sensor C 613c, and an output voltage value V_{d} of the distance sensor D 613d to the control unit 620. The output voltage values Vₐ to V_{d} correspond to values of relative distance to the head 101 of the occupant 100 from the distance sensors A 613a to D 613d, respectively. The output voltage values Vₐ to V_{d} correspond to dₐ to d_{d} in FIG. 2A, respectively. The relative distance from the light receiving element of each distance sensor to the scalp of the head 101 of the occupant 100 is denoted by dₐ to d_{d}, respectively.

The control unit 620 utilizes Equation 1 from the output voltage value Vₐ of the distance sensor A 613a and the output voltage value V_{d} of the distance sensor D613d to calculate posAD. Here, posAD denotes a value corresponding to a difference between relative distance from the distance sensor A613a to the head 101 of the occupant 100 and relative distance from the distance sensor D613d to the head 101 of the occupant 100.

$$\begin{matrix}[ Equation 1 ] & \\ posAD = \frac{{V}_{a} - {V}_{d}}{{V}_{a} + {V}_{d}} & ( Equation 1 )\end{matrix}$$

The control unit 620 utilizes Equation 2 from the output voltage value Vₐ of the distance sensor A 613a and the output voltage value V_{b} of the distance sensor B 613b to calculate posAB. Here, posAB denotes a value corresponding to difference between relative distance from the distance sensor A 613a to the head 101 of the occupant 100 and relative distance from the distance sensor B 613b to the head 101 of the occupant 100.

$$\begin{matrix}[ Equation 2 ] & \\ posAB = \frac{{V}_{a} - {V}_{b}}{{V}_{a} + {V}_{b}} & ( Equation 2 )\end{matrix}$$

The control unit 620 utilizes Equation 3 from the output voltage value V_{c} of the distance sensor C 613c and the output voltage value V_{d} of the distance sensor D 613d to calculate posCD. Here, posCD denotes a value corresponding to difference between relative distance from the distance sensor C 613c to the head 101 of the occupant 100 and relative distance from the distance sensor D 613d to the head 101 of the occupant 100.

$$\begin{matrix}[ Equation 3 ] & \\ posCD = \frac{{V}_{c} - {V}_{d}}{{V}_{c} + {V}_{d}} & ( Equation 3 )\end{matrix}$$

FIGS. 2A and 2B are views showing states of utilizing the distance sensor A 613a and the distance sensor D 613d to calculate posAD, utilizing the distance sensor A 613a and the distance sensor B 613b to calculate posAB, and utilizing the distance sensor C 613c and the distance sensor D 613d to calculate posCD.

FIG. 2A shows a position of the head 101 of the occupant 100 at a certain time. FIG. 2B shows a position of the head 101 of the occupant 100 at a time being different from that of FIG. 2A. In FIG. 2A, the head 101 of the occupant 100 is positioned to satisfy posAD=0.

The control unit 620 utilizes Equation 2 to calculate the value of posAB at the time when the value of posAD becomes a value being equal to zero (i.e., posAB0). The control unit 620 utilizes Equation 3 to calculate the value of posCD at the time when the value of posAD becomes the value being equal to zero (i.e., posCD0) by utilizing Equation 3. The control unit 620 utilizes Equation 4 to determine a coefficient G.

$$\begin{matrix}[ Equation 4 ] & \\ G = \frac{( \frac{Δ x}{posAB 0} - \frac{Δ x}{posCD 0} )}{2} & ( Equation 4 )\end{matrix}$$

The control unit 620 utilizes the coefficient G to acquire a relative position Est₁ or Est₂ of the head 101 of the occupant 100 as will be described later.

The value being equal to zero is defined to include an error range due to noise involved in the output signals from the distance sensors, the shape of the head 101 of the occupant 100 and the like. That is, the value being equal to zero is defined not to be exact zero but to be a value within a certain error range.

The control unit 620 utilizes Equation 5 to calculate Est₁ when the head 101 of the occupant 100 is positioned on the left side of the first midpoint 514 (i.e., the side toward the third midpoint 516 from the first midpoint 514) as in FIG. 2B. In this case, posAD is equal to or larger than zero. Est₁ denotes an estimated value of relative distance between the geometric barycenter of the head 101 of the occupant 100 and the first line 514a.

[Equation 5]

Est₁=G×(posAB−posAB0) (Equation 5)

The control unit 620 provides a command to the drive unit 164 so that the projection range 113 of the light flux 112 is moved by the distance of Est₁ from a reference position in the direction along a line segment connecting the first midpoint 514 and the third midpoint 516. Receiving the command, the drive unit 164 drives the reflection plate 163.

The control unit 620 utilizes Equation 6 to calculate Est₂ and controls the reflection plate 163 when the head 101 of the occupant 100 is positioned at the right side of the first midpoint 514 (i.e., the side toward the second midpoint 515 from the first midpoint 514) in FIG. 2A. In this case, posAD is negative. Est₂ denotes an estimated value of relative distance between the geometric barycenter of the head 101 of the occupant 100 and the first line 514a.

[Equation 6]

Est₂=G×(posCD−posCD0) (Equation 6)

The control unit 620 provides a command to the drive unit 164 so that the projection range 113 of the light flux 112 is moved by the distance of Est₂ from the reference position in the direction along a line segment connecting the first midpoint 514 and the second midpoint 515. Receiving the command, the drive unit 164 drives the reflection plate 163.

The occupant 100 performs initialization of the display device 10 in a state that the head 101 is at the position satisfying posAD=0 (i.e., the state of FIG. 2A). At that time, the occupant 100 adjusts the position of the reflection plate 163 so that the projection range 113 of the light flux 112 includes the one eye 105 of the occupant 100. The position of the one eye 105 of the occupant 100 in this state is to be the reference position.

Here, the position of the reflection plate 163 includes a position due to translational motion and an angle position due to rotational motion.

The control unit 620 calculates Est₁ or Est₂ during usage of the display device 10. The control unit 620 provides a command (i.e., outputs a signal) to the drive unit 164 so that the projection range 113 of the light flux 112 is moved by the distance of Est₁ or Est₂ from the reference position in the direction along the line segment connecting the first midpoint 514 and the second midpoint 515. Receiving the command, the drive unit 164 drives the reflection plate 163.

For example, if the calculation result of Est₁ becomes +5 when posAD is equal to or larger than zero, the control unit 620 provides a command to the drive unit 164 so that the projection range 113 of the light flux 112 is moved by 5 cm from the reference position in the direction toward the third midpoint 516 from the first midpoint 514 to adjust the position of the reflection plate 163. Receiving the command, the drive unit 164 drives the reflection plate 163.

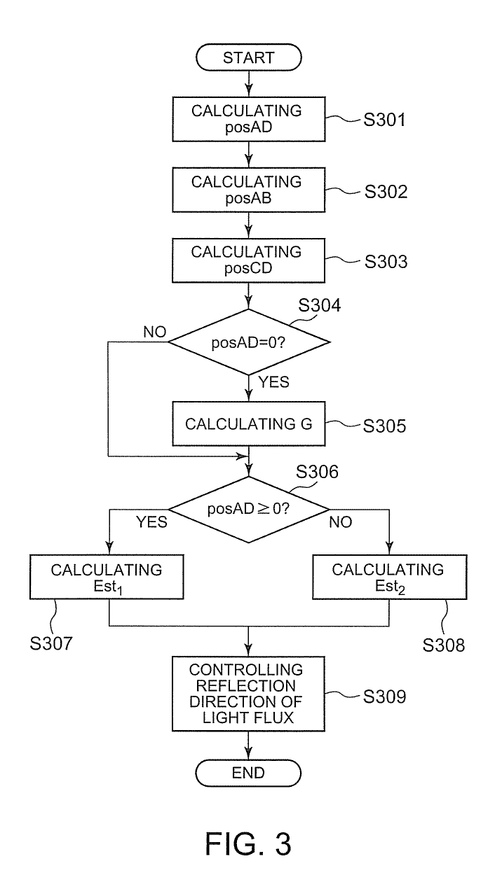

FIG. 3 is a flowchart showing an example of a method to control the control unit 620. The control method shown in FIG. 3 starts from a state that an initial coefficient G is previously provided to the control unit 620 during a manufacturing stage of the display device 10. Alternately, the method may start from a state that the head 101 is firstly moved to a position satisfying posAD=0 and the initial coefficient G is calculated by the control unit 620 when the occupant 100 starts to use the display device 10.

As shown in FIG. 3, the control unit 620 utilizes the output voltage value of the distance sensor A 613a and the output voltage value of the distance sensor D 613d to calculate posAD with Equation 1 (S301). The control unit 620 utilizes the output voltage value of the distance sensor A 613a and the output voltage value of the distance sensor B 613b to calculate posAB with Equation 2 (S302). The control unit 620 utilizes the output voltage value of the distance sensor C 613c and the output voltage value of the distance sensor D 613d to calculate posCD with Equation 3 (S303). Steps S301 to S303 are repeatedly performed for each sampling time. Steps S301 to S303 are performed in random order.

The control unit 620 determines whether or not the value of posAD is the value being equal to zero (S304). In addition to the above determination, it is also possible that the control unit 620 determines whether or not posCD is smaller than zero and the posAB is larger than zero. When the determination in step S304 is “YES”, the control unit 620 calculates the coefficient G with Equation 4 from the value of posCD (i.e., posCD0) and the value of posAB (i.e., posAB0) at that time (S305).

The control unit 620 determines whether or not posAD is equal to or larger than zero (S306). When the determination result in Step S306 is “YES”, the control unit 620 calculates Est₁ with Equation 5 (S307). When the determination result in Step S306 is “NO”, the control unit 620 calculates Est₂ with Equation 6 (S308).

The control unit 620 controls the reflection direction of the light flux 112 on the basis of the result of Step S307 or Step S308 (S309).

With this method, conversion process from output voltage values into the distance of the head 101 of the occupant 100 can be eliminated, thereby enabling it to reduce processing cost. Further, the measurement can be performed without correction due to temperatures, individual differences and the like, thereby enabling it to enhance robustness.

In this manner, the display device 10 according to the present embodiment enables it to provide a display device capable of tracing the position of one eye of an occupant without requiring high image processing capability. In addition, it is possible to provide a display device capable of presenting a projected image to one eye of an occupant robustly without being affected by external light and the like.

The present embodiment is described as an example and is not intended to limit the scope of the invention. The present embodiment can be actualized variously, so that various skipping, replacing and modifying can be performed without departing from the substance of the invention. The present embodiment and modifications thereof are included in the scope of the invention described in the claims and equivalence thereof while being included in the scope or substance of the invention.

While a certain embodiment of the invention has been described, the embodiment has been presented by way of examples only, and is not intended to limit the scope of the inventions. Indeed, the novel elements and apparatuses described herein may be embodied in a variety of other forms; furthermore, various omissions, substitutions and changes in the form of the methods described herein may be made without departing from the spirit of the invention. The accompanying claims and their equivalents are intended to cover such forms or modifications as would fall within the scope and spirit of the invention.

What is claimed is:

1. A display device comprising:
a light flux generating unit to generate light flux containing image information;
a reflection plate to reflect the light flux generated by the light flux generation unit toward one eye of an occupant;
a head detection unit to detect a position of a head of the occupant;
a control unit to control a position of the reflection plate based on output from the head detection unit; and
a drive unit to drive the reflection plate on the basis of output from the control unit;
wherein
the head detection unit utilizes a first distance sensor pair including a distance sensor A and a distance sensor B and a second distance sensor pair including a distance sensor C and a distance sensor D to detect the position of the head of the occupant;
the control unit calculates a coefficient G from an output voltage difference of the first distance sensor pair and an output voltage difference of the second distance sensor pair when an output voltage of the distance sensor A and an output voltage of the distance sensor D become substantially equal to each other; and
the control unit controls a direction or a position of the reflection plate on the basis of the coefficient G and either the output voltage difference of the first distance sensor pair or the output voltage difference of the second distance sensor pair.

2. The display device according to claim 1, wherein
the control unit controls the direction or the position of the reflection plate on the basis of the output voltage difference of the first distance sensor pair and the coefficient G if the output voltage of the distance sensor A is equal to or higher than the output voltage of the distance sensor D, or controls the direction or the position of the reflection plate on the basis of the output voltage difference of the second distance sensor pair and the coefficient G if the output voltage of the distance sensor A is lower than the output voltage of the distance sensor D.

3. The display device according to claim 2, wherein
the light flux generation unit includes:
a light source;
a restriction portion to restrict a traveling direction of light flux from the light source;
a diffusion portion to diffuse the light flux;
an image unit to make image information contained in the light flux which is diffused by the diffusion portion;
a first lens to condense the light flux passing through the image unit;
an opening portion to control a divergence angle of the light flux passing through the first lens; and
a second lens to condense the light flux passing through the opening portion.
